(19) United States
(12) Patent Application Publication
(10) Pub. No.: US 2005/0141724 A1
(43) Pub. Date: Jun. 30, 2005

(54) Loudspeaker positions select infrastructure signal

(76) Inventor: Piet Bernard Hesdahl, Eindhoven (NL)

Correspondence Address: Phillips Electronics North America Corporation;Corporate Patent Counsel, PO Box 3001, Briarcliff Manor, NY, 10510, US

(21) Appl. No.: 10/510,782

(22) PCT Filed: Mar. 11, 2003
(86) PCT No.: PCT/IB03/00953

(30) Foreign Application Priority Data
Apr. 17, 2002 (EP) 02076496.5

(51) Int. Cl. H04R 29/00

(52) U.S. Cl. 381/58

(57) ABSTRACT

For operating a multi-loudspeaker configuration which is audio-driven from a multi-audio-channel source system, an appropriate audio channel from the multi-audio-channel source is assigned to each loudspeaker. The loudspeakers are driven as active powered units. In particular, the method provides an overall communication structure for carrying audio data to the loudspeakers. The method locally ascertains the relative positions of various loudspeakers in the configuration. It assigns an appropriate indication to a particular loudspeaker regarding its relative position. In the particular loudspeaker, it recognizes an associated indication. It uses a recognized indication to select an audio channel appropriate to the position of the loudspeaker in question in the multi-loudspeaker configuration.

The invention relates to a method of operating a multi-loudspeaker configuration which is audio-driven from a multi-audio-channel source system as described in the pre-characterizing part of claim 1.

In many current home audio and home cinema systems, various loudspeakers are connected through interconnection wires to an audio control center or an audio preamplifier facility. Such systems may have multiple loudspeakers in various different, and sometimes even time-varying configurations. The number of loudspeakers that is actually active may vary from one in a monosystem to relatively high numbers such as up to eight in quadrophonic, surround and other sophisticated set-ups. A standard policy for interconnecting the loudspeakers is to provide each loudspeaker box, or loudspeaker for short, with its own wire or wires interconnected to the central station. Such a wire would provide the power, as well as the information to the loudspeaker in question. Changing the system configuration, or even changing to a different audio representation, such as from a two-channel to an eight-channel representation could necessitate rewiring of the system.

Prior art has recognized the possibility to separate the routing of the audio data from the provision of power to the loudspeakers, such as by using a pre-existing powerline network to carry data as an additional feature of such a network. Appropriate filtering between data and power would allow the loudspeaker to get the audio amplified and outputted. Another proposal has used wireless communication of the data to the loudspeakers.

However, the inventor has recognized a user's difficulties when the wrong audio channel is assigned to a particular loudspeaker, for example, through an erroneous location and/or erroneous wiring of the loudspeaker in question.

It is therefore an object of the present invention to allow an easy set-up procedure which ensures that each respective loudspeaker gets its assigned correct audio channel.

According to one of its aspects, the invention is characterized as defined in the characterizing part of claim 1.

The invention also relates to an audio reproduction system which may comprise a multi-loudspeaker configuration, which system is arranged to implement a method as defined in claim 1, and to an active loudspeaker arranged for use in such a system. Further advantageous aspects of the invention are defined in the dependent claims.

These and further aspects and advantages of the invention will be discussed in more detail hereinafter with reference to the disclosure of preferred embodiments, and in particular with reference to the appended Figures in which

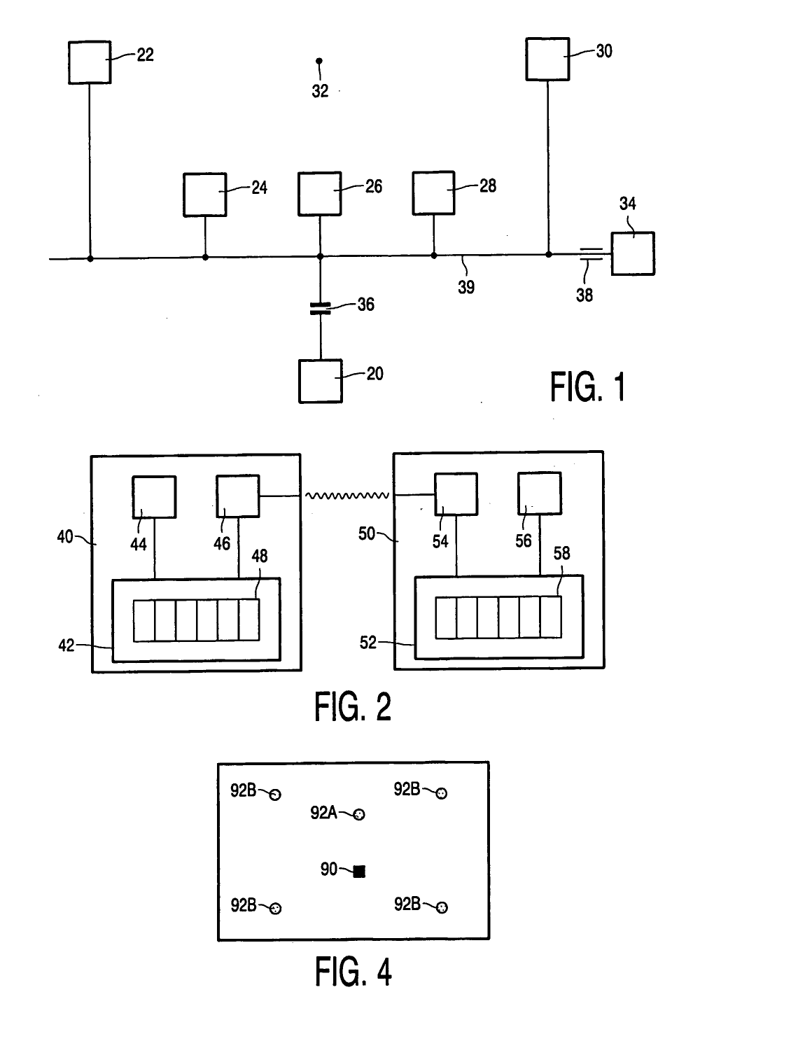

FIG. 1 shows a multi-loudspeaker audio configuration;

FIG. 2 shows a two-loudspeaker GPS-based approach;

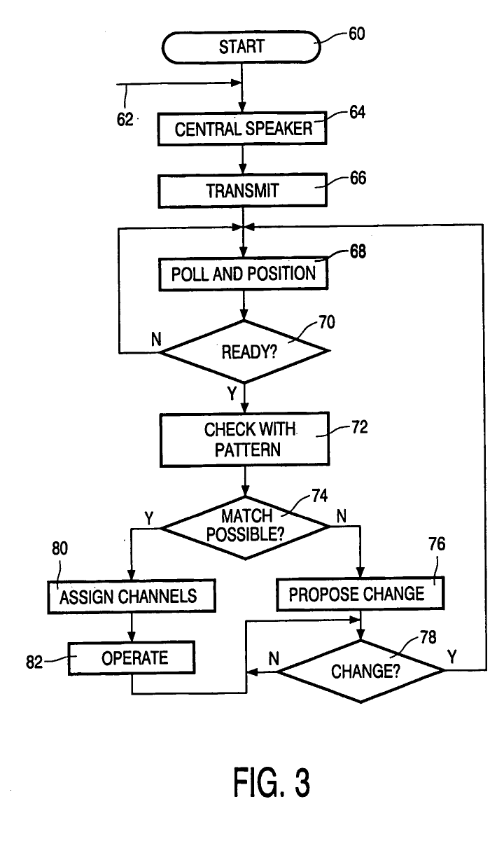

FIG. 3 shows a GPS-based approach to an operating flow chart;

FIG. 4 shows a template-based setting embodiment for a single loudspeaker.

FIG. 1 illustrates a multi-loudspeaker audio configuration shown, by way of example, from above. Note that not all loudspeakers need to be positioned in a single plane. In the Figure, an audio source control station 20 generates multi-stream audio information. Through separation filter 36, shown as being capacitive for blocking low-frequency signals, this information is superimposed on a powerline 39. All interconnections have been shown as single-wire, although in practice, two wires are often used in parallel. The powerline is powered by power source 34 through separation filter 38 shown as being inductive for blocking high-frequency signals. In the configuration shown, there are five loudspeaker boxes 22, 24, 26, 28, 30, which are positioned with respect to a user 32 in such a way that they provide an optimum audio reproduction. For this reason, each loudspeaker should receive appropriate audio channel information. In certain situations, two or more loudspeakers may share an audio stream, for example, when reproducing mono or stereo audio with a larger number of loudspeakers, such as five in the configuration shown. Moreover, the various loudspeakers may vary in actual power level, spectrum, etc., such as in woofers or tweeters, or the like. A skilled listener will recognize that the configuration could become erroneous through the interchange of two or more loudspeakers, and/or through a displacement of one or more of the loudspeakers outside an appropriate optimum range. The present invention therefore provides a system ensuring that the appropriate channel is assigned to a particular loudspeaker, and provides a user with information about rearranging the loudspeakers. Other possibilities for the audio stream are a wired data network, a telephone network, or another wireless communication network.

FIG. 2 illustrates a two-loudspeaker GPS-based approach. For simplicity, only the data processing elements have been shown. Each loudspeaker 40, 50 has a GPS facility 44, 54 for determining the actual position of the loudspeaker in question. Furthermore, the loudspeaker has a communication facility 46, 56, which may communicate with the other loudspeaker(s) and/or with the central control box such as item 20 in FIG. 1. Finally, each loudspeaker 40, 50 has a local processing facility 42, 52, which contains a register set 48, 58 and receives the local position of the various loudspeakers for processing and storage. Through careful consideration thereof, the correct assignment of the various channels to the respective loudspeakers could be performed. By way of embodiment, the processing of the various positional data could be executed in central control box 20 in FIG. 1. As regards accuracy of GPS and similar measuring procedures, it is well known that sub-meter accuracies have been proved feasible, which would be quite sufficient in a domestic or similar environment. Note in particular that systematic errors which influence all position determinations for the configuration in question are inconsistent: only the relative positions of the loudspeakers viz à viz each other will be relevant.

In the two-channel set-up, the outcome of the position determinations could be, for example, left and right interchanged, too far apart, too close to each other, and correct. The correct configuration could imply, for example, a distance between the two loudspeakers of two meters minimum, five meters maximum.

FIG. 3 illustrates a GPS-based approach to an operating flow chart. In block 60, the system is started up, and the necessary hardware and software facilities are assigned. In block 64, the central loudspeaker is addressed by the control box (item 20 in FIG. 1). If appropriate, the control box may be co-located with the central loudspeaker. The control box determines the GPS location of the central loudspeaker (item 26 in FIG. 1), and also, by means of an internal compass of the latter, its orientation. If appropriate, these data are transmitted next to the central control box. In block 68, the central control box will poll one of the other loudspeakers and retrieve the position thereof. Generally, but not by way of restriction, it will not be necessary to again find the compass orientation of the other loudspeakers. In block 70, central control finds out whether all loudspeakers have reported. If not, the system goes on polling in block 68.

If ready, the system checks, in block 72, the actual loudspeaker configuration so found against a standard pattern of the loudspeakers. For one, this compares with a scale factor, such as determined through comparison with an optimum distance between outer loudspeaker pair 22, 30 in FIG. 1. Next, central control tries to match the actual loudspeaker configuration with an optimum configuration. For example, if loudspeakers 24, 28 have identical facilities, they could be exchanged without other problems than the necessary correct assignment of the associated left/right audio data streams. However, other exchanges could be forbidden. Also, variations in the distances between adjacent loudspeakers could be different from the optimal conditions. Generally, the procedure followed is democratic in that the actual overall configuration of the loudspeakers is determined and checked against a standard configuration, without the checking being preferably based on only a subset of all loudspeakers in the actual configuration.

In block 74, central control checks whether a suitable match can be made between the actual and the optimal configuration. If wrong, the system proposes a change in block 76, by proposing to move the outmost loudspeakers in a direction towards or away from the center. If a change executed by the user is detected in block 78, the polling procedure is repeated, from block 68 on as shown, or even by a retry, starting with block 64 through arrow 62. However, if the configuration is acceptable, the various correct channels are assigned in block 80 to the loudspeakers, and in block 82, the system will be operated accordingly. Here again the change detection in block 78 may remain active. If no change occurs, this block 78 operates as a waiting loop. The overall organization has been simplified for better understanding. The step of leaving the operation has been omitted. Furthermore, the system may have an overruling feature, if the user does not want to produce an optimal configuration at the present moment.

FIG. 4 illustrates a template-based setting embodiment for a single loudspeaker. The inventor has recognized that this is a particularly user-friendly and low-cost solution for the instant problem. The intended placement diagram or template has been provided at the rear side of each loudspeaker box. In every position in the placement diagram (again as seen from above) where a loudspeaker may be placed, a light-emitting device or other indication element such as a LCD is mounted. By pressing a single pushbutton 90 or other similar element, a single light-emitting device 92A, 92B can be lit, to indicate where the box in question is located. Pressing the pushbutton 90 will toggle between the various positions, such as according to a standard sequence. In the LEDs, a red light 92A will indicate a “selected” position, whereas green positions 92B are “available”. After selection, the loudspeaker will be able to receive and output the correct audio channel in accordance with this selection.

1. A method of operating a multi-loudspeaker configuration which is audio-driven from a multi-audio-channel source system, assigning an appropriate audio channel to each loudspeaker from the channels of said multi-audio-channel source, whilst driving each of said loudspeakers as an active powered unit,
said method being characterized in that it comprises the following steps:
providing an overall communication infrastructure for carrying audio data from said source to the various loudspeakers;
locally ascertaining relative positions of various loudspeakers in said multi-loudspeaker configuration;
assigning an appropriate indication to a particular loudspeaker regarding its relative position;
recognizing an associated indication in said particular loudspeaker;
and using the recognized indication to select an audio channel appropriate to the position of the loudspeaker in question in said multi-loudspeaker configuration.

2. A method as claimed in claim 1, executing said steps for all loudspeakers in said multi-loudspeaker configuration.

3. A method as claimed in claim 1, wherein said relative positions are ascertained through a self-operative position determination procedure among said loudspeakers.

4. A method as claimed in claim 3, based on a GPS procedure.

5. A method as claimed in claim 4, wherein said procedure is democratic.

6. A method as claimed in claim 1, wherein said relative positions are user-selected through a position template provided on various loudspeakers.

7. A method as claimed in claim 1, wherein the infrastructure is one of a powerline network, a wired data network, a telephone network, or another wireless communication network.

8. An audio reproduction system comprising a multi-loudspeaker configuration, which system is arranged to implement a method as claimed in claim 1, for operating the loudspeaker configuration which is audio-driven from a multiple-audio-channel source system, and having assignment means for assigning an appropriate audio channel to each loudspeaker from the multiple channels, each of said loudspeakers having a drive input so as to be driven as an active powered unit,
said system being characterized by an overall communication infrastructure for carrying audio data from said source to the various loudspeakers, local ascertaining means for ascertaining relative positions of various loudspeakers in said multi-loudspeaker configuration, assignment means fed by said ascertaining means for assigning an appropriate indication to a particular loudspeaker regarding its relative position, recognizing means for recognizing an associated indication in said particular loudspeaker, and selecting means fed by said recognizing means for selecting, from the recognized indication, an audio channel appropriate to the position of the loudspeaker in question in said multi-loudspeaker configuration.

9. A system as claimed in claim 8, wherein said ascertaining means are arranged to ascertain the relative positions through a self-operative position determination procedure among said loudspeakers.

10. A system as claimed in claim 9, wherein each loudspeaker has a GPS facility for determining a relative position viz à viz other loudspeakers in said configuration.

11. A system as claimed in claim 8, wherein said loudspeakers have a selection facility for user-selecting relative positions through a position template provided on various loudspeakers.

12. An active loudspeaker arranged for use in a system as claimed in claim 8 for implementing a method as claimed in claim 1, said loudspeaker having assignment means for assigning an appropriate audio channel thereto from the multiple channels, and having a drive input so as to be driven as an active powered unit,
said loudspeaker being characterized by a carrying interface for receiving, from an overall communication infrastructure, audio data from said source to the loudspeaker in question, ascertaining means for ascertaining a relative position of the loudspeaker in said multi-loudspeaker configuration, assignment means fed by said ascertaining means for assigning an appropriate indication to the loudspeaker regarding its relative position, recognizing means for recognizing an associated indication in said loudspeaker, and selecting means fed by said recognizing means for selecting, from the recognized indication, an audio channel appropriate to the position of the loudspeaker in question in said multi-loudspeaker configuration.

13. A loudspeaker as claimed in claim 12, further having a GPS facility for determining its relative position viz à viz one or more other loudspeakers in said configuration.

14. A loudspeaker as claimed in claim 12, further having a selection facility for user-selecting a relative position through a position template provided on the loudspeaker in question.
